(19) United States
(12) Patent Application Publication
(10) Pub. No.: US 2007/0162665 A1
(43) Pub. Date: Jul. 12, 2007

(54) Combination apparatus capable of data communication between host devices and method thereof

(75) Inventor: Ho-shin Lee, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/500,956

(22) Filed: Aug. 9, 2006

(30) Foreign Application Priority Data
Dec. 5, 2005 (KR) 2005-117637

(51) Int. Cl. G06F 13/38

(52) U.S. Cl. 710/62

(57) ABSTRACT

A combination apparatus capable of data communication between host devices and a data communication method thereof are provided. The combination apparatus includes a first host device that controls a first function block to perform a first function, a second host device that controls a second function block to perform a second function, and an advanced technology attachment (ATA) adjuster that performs a data communication between the first host device and the second host device through an ATA packet interface. Accordingly, the data communication is more effectively performed between the host devices.

### CROSS-REFERENCE TO RELATED APPLICATIONS

This application claims the benefit under 35 U.S.C. §119(a) of Korean Patent Application No. 2005-117637, filed Dec. 5, 2005 in the Korean Intellectual Property Office, the entire disclosure of which is hereby incorporated by reference.

### BACKGROUND OF THE INVENTION

1. Field of the Invention

The present invention relates to a combination apparatus capable of data communication between host devices and a method thereof. More particularly, the present invention relates to a combination apparatus capable of data communication between host devices, which performs a data communication between two host devices employed therein using an advanced technology attachment (ATA) packet interface, and a method thereof.

2. Description of the Related Art

In order to satisfy consumers' various demands, combination apparatuses, which integrate various functions into a single apparatus, are increasingly being developed. The combination apparatuses include a mobile phone having a digital camera function, a digital camera having a digital camcorder function, and a set-top box having a DVD function. With the development of technology, the variety of combination apparatuses increases.

The combination apparatus comprises function blocks to perform various functions and host devices to control the respective function blocks. For example, the combination apparatus comprises a first host device to perform a first function and a second host device to perform a second function. The first host device and the second host device systemically control functions of the combination apparatus through mutual data communications.

The combination apparatus in the related art has to comprise a third host device to perform the data communication between the first and the second host devices.

FIG. 1 is a block diagram illustrating a conventional combination apparatus.

Referring to FIG. 1, the conventional combination apparatus comprises a first host device 10, a second host device 20, and a third host device 30.

The first host device 10 and the second host device 20 control function blocks (not shown) to perform their respective functions.

The third host device 30 controls the first and the second host devices 10, 20 to perform a data communication therebetween. The third host device 30 controls the first and the second host devices 10, 20 through a peripheral component interconnect (PCI) or Ethernet.

For example, a set-top box, which has a DVD function, comprises a DVD decoder to perform the DVD function and a moving picture experts group (MPEG)-2 decoder to receive and process a digital broadcast signal. The set-top box comprises a main host device to control the DVD decoder and the MPEG-2decoder to transmit and receive data such as joint photographic expert group (JPEG) and MP 3 therebetween.

Due to the additional employment of the main host device, however, the combination apparatus has a complicated system structure and increases power consumption. Also, since the combination apparatus is subjected to a load when performing a certain function, it causes user inconvenience. Furthermore, the main host device requires a large number of components, which causes a cost of the combination apparatus to be increased.

Accordingly, there is a need for an improved apparatus and method for communicating data between host devices.

### SUMMARY OF THE INVENTION

An exemplary aspect of the present invention is to address at least the above problems and/or disadvantages and to provide at least the advantages described below. Accordingly, exemplary embodiments of the present invention provide a combination apparatus capable of data communication between host devices, which performs a data communication between host devices using an advanced technology attachment (ATA) packet interface without requiring an additional host device, and a data communication method thereof.

The above exemplary aspect is achieved by providing a combination apparatus comprising a first host device that controls a first function block to perform a first function, a second host device that controls a second function block to perform a second function, and an advanced technology attachment (ATA) adjuster that performs a data communication between the first host device and the second host device through an ATA packet interface.

In an exemplary embodiment, the ATA adjuster comprises a first ATA part that receives at least one of a read command and a write command from the first host device, a second ATA part that receives the at least one command from the first ATA part and transmits the received command to the second host device, a first buffer that temporarily stores data transmitted from at least one of the first host device and the first ATA part according to the at least one command, a second buffer that temporarily stores data transmitted from at least one of the second host device and the second ATA part according to the at least one command, and an SRAM that stores data transmitted from at least one of the first ATA part and the second ATA part.

In an exemplary embodiment, the first ATA part stores the data temporarily stored in the first buffer to the SRAM and then transmits to the second ATA a storage completion signal indicating that the data has been stored to the SRAM, and the second ATA part transmits the data stored in the SRAM to the second buffer when receiving the storage completion signal.

In an exemplary embodiment, when the first host device transmits data to the second host device, the first host device temporarily stores the data in the first buffer and the second host device reads out the data temporarily stored in the second buffer.

In an exemplary embodiment, the ATA adjuster transmits and receives the data through a parallel ATA (PATA) packet interface.

In an exemplary embodiment, the combination apparatus further comprises a serial/parallel converter that, if the first host device performs a data communication through a serial ATA (SATA) packet interface, converts the SATA packet interface performed between the first host device and the ATA adjuster into a PATA packet interface and converts a PATA packet interface into a SATA packet interface.

The above exemplary aspect may also be achieved by providing a data communication method of a combination apparatus which performs a data communication between a first host device and a second host device through a PATA packet interface. The method comprises receiving at least one of a read command and a write command from the first host device, transmitting a busy signal to the first host device when receiving the read command, transmitting the read command to the second host device, and receiving data corresponding to the read command from the second host device and transmitting the data to the first host device through a PATA packet interface.

In an exemplary embodiment, if the first host device uses a SATA packet interface, the operation of transmitting the data to the first host device through the PATA packet interface converts the PATA packet interface into the SATA packet interface and then transmit the data.

In an exemplary embodiment, the method further comprises if the write command is received, receiving data corresponding to the write command from the first host device, transmitting a busy signal to the first host device, transmitting the write command to the second host device, and transmitting the data to the second host device through a PATA packet interface.

In an exemplary embodiment, if the first host device uses a SATA packet interface, the operation of transmitting the data to the second host device through a PATA packet interface is performed after the SATA packet interface is converted into a PATA packet interface.

The above exemplary aspect may also be achieved by providing a set-top box having a DVD function, comprising a HDD that stores joint photographic experts group (JPEG) and digital internet video express (DIVX) format video data and moving picture experts group layer 3 (MP3) format audio data, an MPEG-2 decoder that reads out at least one data of the JPEG and DIVX format video data and the MP3 format audio data from the HDD, an S/P converter that converts the data read by the MPEG-2 decoder through a SATA packet interface into data that is compatible through the PATA packet interface, an ATA adjuster that performs a data communication with respect to the data through the PATA packet interface, and a DVD decoder that receives the data through the ATA adjuster.

In an exemplary embodiment, the DVD decoder converts the data into international radio consultative committee (CCIR) 656 format video data and inter-IC sound (I2S) format audio data, and transmit the converted data to the MPEG-2 decoder.

In an exemplary embodiment, the MPEG-2 decoder receives the CCIR 656 format video data and the I2S format audio data and outputs the data as a video and an audio.

The above exemplary aspect may also be achieved by providing a content reproducing method comprising reading out at least one of JPEG and DIVX format video data and MP3 format audio data, performing a data communication with respect to the data through a PATA packet interface, converting the data into CCIR 656 format video data and I2S format audio data, and outputting the CCIR 656 format video data and the I2S format audio data as a video and an audio.

The method may further comprise converting the data read through a SATA packet interface into data that is compatible through a PATA packet interface.

Other objects, advantages, and salient features of the invention will become apparent to those skilled in the art from the following detailed description, which taken in conjunction with the annexed drawings, discloses exemplary embodiments of the invention.

### BRIEF DESCRIPTION OF THE DRAWINGS

The above and other objects, features, and advantages of a certain exemplary embodiment of the present invention will be more apparent from the following description taken in conjunction with the accompanying drawings, in which:

FIG. 1 is a block diagram illustrating a conventional combination apparatus;

FIG. 2 is a block diagram illustrating a combination apparatus according to an exemplary embodiment of the present invention;

FIGS. 3A to 3B are views illustrating data communications performed between host devices of the combination apparatus according to an exemplary embodiment of the present invention;

FIG. 4 is a block diagram illustrating a set-top box having a DVD function, which is one example of the combination apparatus according to an exemplary embodiment of the present invention; and

FIG. 5 is a flowchart illustrating a reproducing operation of the set-top box having a DVD function according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiment described herein can be made without departing from the scope and spirit of the invention. Also, descriptions of well-known functions and constructions are omitted for clarity and conciseness.

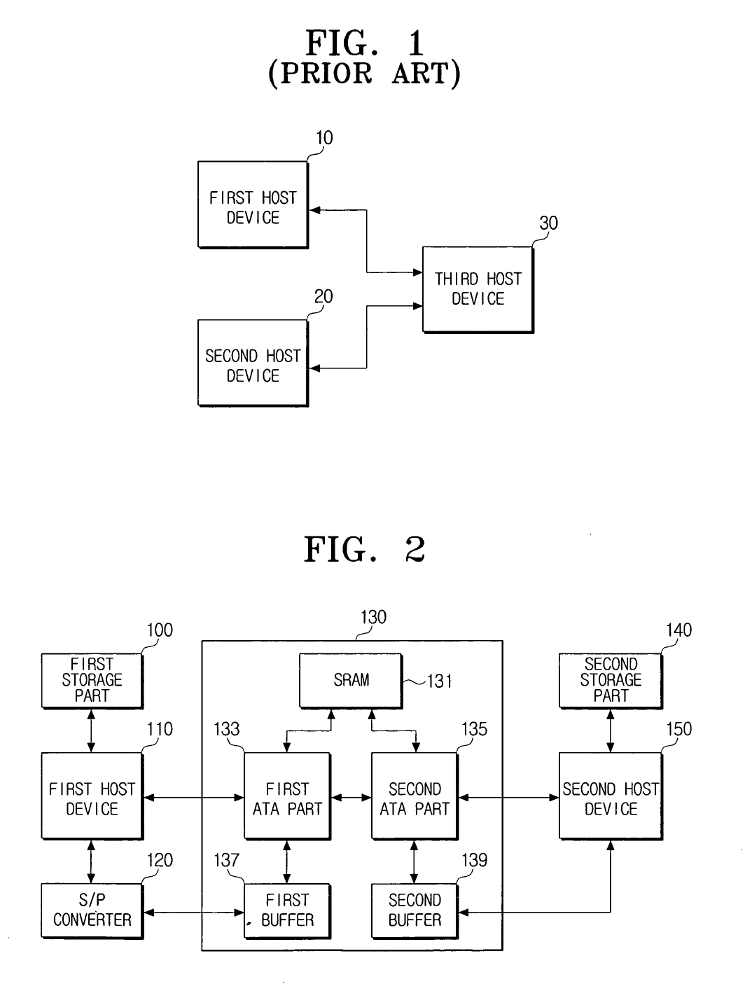

FIG. 2 is a block diagram illustrating a combination apparatus according to an exemplary embodiment of the present invention.

Referring to FIG. 2, the combination apparatus comprises a first storage part 100, a first host device 110, a serial/parallel converter 120, an advanced technology attachment (ATA) adjuster 130, a second storage part 140, and a second host device 150.

The first and the second storage parts 100, 140 store data of a certain format. For example, the first and the second storage parts 100, 140 store joint photographs experts group (JPEG) image data, digital internet video express (DIVX) format video data and moving picture experts group layer 3 (MP3) format audio data.

The first host device 110 controls a first function block (not shown) to perform a first function and transmits the data stored in the first storage part 100 to the ATA adjuster 130 through the S/P converter 120. The first host device 110 receives data from the ATA adjuster 130 through the S/P converter 120 and stores the received data in the first storage part 100.

The S/P converter 120 converts a serial ATA (SATA) packet interface into a parallel ATA (PATA) packet interface or performs a reverse converting operation. For example, if the first host device 110 performs a data communication through the SATA packet interface, the S/P converter 120 enables interface compatibility between the first host device 110 and the ATA adjuster 130 which performs a data communication through the PATA packet interface.

More specifically, the S/P converter 120 receives data from the first host device 110 through the SATA packet interface and transmits the data to the ATA adjuster 130 through the PATA packet interface. In the reverse way, the S/P converter 120 receives data from the ATA adjuster 130 through the PATA packet interface method, converts the data into data compatible through the SATA packet interface, and transmits the data to the first host device 110. If the host device 110 performs a data communication through the PATA packet interface, the S/P converter 120 may not be included in the combination apparatus of the present invention.

The ATA adjuster 130 performs data communications with respect to the first and the second host devices 110, 150 through the PATA packet interface, and comprises an SRAM 131, a first ATA part 133, a second ATA part 135, a first buffer 137, and a second buffer 139.

The first ATA part 133 communicates with the first host device 110 according to a general purpose input/output (GPIO) method to receive and transmit a read command and a write command. The first ATA part 133 transmits the read command and the write command received from the first host device 110 to the second ATA part 135, or transmits a read command and a write command transmitted from the second ATA part 135 to the first host device 110. The first ATA part 133 stores data temporarily stored in the first buffer 137 to the SRAM 131, or stores data stored in the SRAM 131 to the first buffer 137 at the request of the second ATA part 135.

The second ATA part 135 communicates with the second host device 150 according to the GPIO method to receive and transmit a read command and a write command. Also, the second ATA part 135 transmits the read command and the write command received from the second host device 150 to the first ATA part 133, or transmits the read command and the write command transmitted from the first ATA part 133 to the second host device 150. The second ATA part 135 stores data temporarily stored in the second buffer 139 to the SRAM 131, or stores data stored in the SRAM 131 to the second buffer 139 at the request of the first ATA part 133.

The first buffer 137 temporarily stores data transmitted from the first host device 110, or temporarily stores data stored in the SRAM 131.

The second buffer 139 temporarily stores data transmitted from the second host device 150, or temporarily stores data stored in the SRAM 131.

The SRAM 131 stores the data temporarily stored in the first buffer 137 under the control of the first ATA part 133, or stores the data temporarily stored in the second buffer 139 under the control of the second ATA part 135.

The second host device 150 controls a second function block (not shown) to perform a second function, and transmits the data stored in the second storage part 140 to the ATA adjuster 130. The second host device 150 reads out data from the second buffer 139 and stores the data in the second storage part 140.

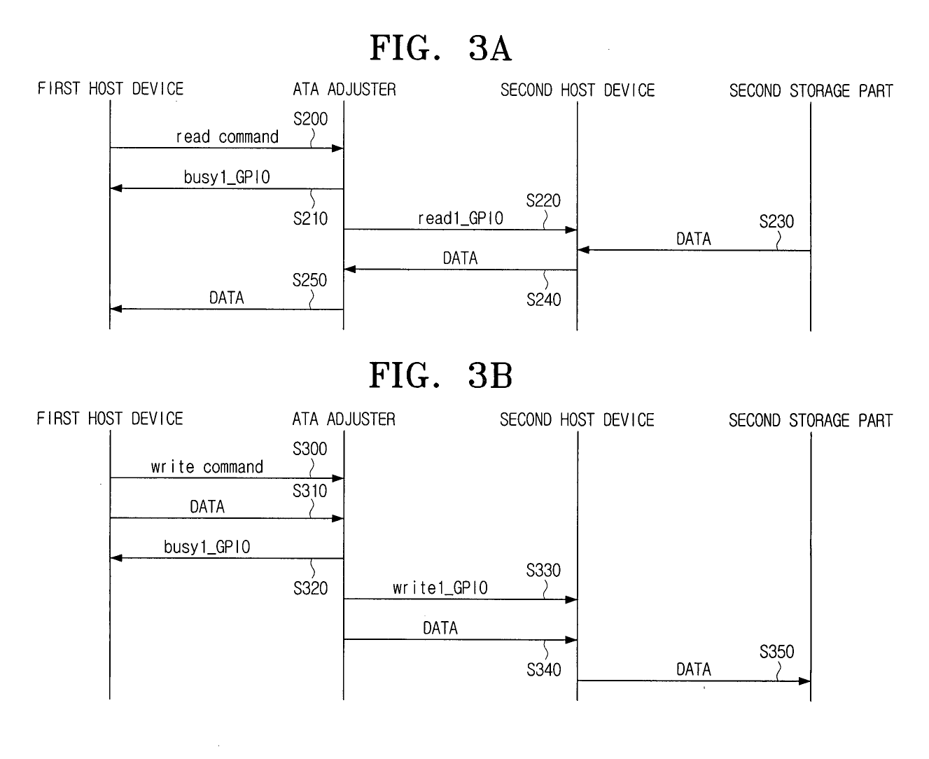

FIGS. 3A and 3B are views illustrating data communications performed by the host devices of the combination apparatus according to an exemplary embodiment of the present invention.

FIG. 3A is a view illustrating a method in which the first host device 110 reads out data from the second storage part 140.

Referring to FIG. 3A, the first host device 110 transmits a read command to the ATA adjuster 130 at operation S200. The read command includes a sector counter indicating the number of data to read and an address indicating a location where the data is stored.

The ATA adjuster 130 transmits a GPIO busy signal ‘busy1_GPIO’ to the first host device 110 not to receive another command from the first host device 110 while processing the read command at operation S210. More specifically, the first ATA part 133 transmits the read command to the second ATA part 135, and simultaneously transmits the GPIO busy signal ‘busy1_GPIO’ to the first host device 110.

The second ATA part 135 converts the received read command into a GPIO read command ‘read1_GPIO’, and transmits the GPIO read command ‘read1_GPIO’ to the second host device 150 at operation S220.

On receipt of the read GPIO command ‘read1_GPIO’ from the second ATA part 135, the second host device 150 refers to the address and reads out data from the second storage part 140 as much as the sector count at operation S230.

The second host device 150 transmits the read data to the ATA adjuster 130, and the data is temporarily stored in the second buffer 139 at operation S240.

The second ATA part 135 stores the data temporarily stored in the second buffer 139 to the SRAM 131 and then transmits to the first ATA part 133 a storage completion signal indicating that the data has been stored in the SRAM 131. The first ATA part 133 temporarily stores the data stored in the SRAM 131 to the first buffer 137 and clears the busy signal ‘busy1_GPIO’ of the first host device 110.

The first host device 110 reads out the data stored in the first buffer 137 when the busy signal ‘busy1_GPIO’ is cleared at operation S250. Herein, if the first host device 110 performs a data communication through the SATA packet interface, the S/P converter 120 receives the data from the first buffer 137 through the PATA packet interface, converts the data into data compatible through the SATA packet interface, and transmits the data to the first host device 110.

FIG. 3B is a view illustrating a method in which the first host device 110 writes data to the second storage part 140.

Referring to FIG. 3B, the first host device 110 transmits a write command to the ATA adjuster 130 at operation S300. The write command includes a sector count indicating the number of data to write to the second storage part 140 and an address indicating a location where the data is stored.

The first host device 110 transmits data to the ATA adjuster 130 at operation S310. Herein, if the first host device 110 performs a data communication through the SATA packet interface, the S/P converter 120 receives the data from the first host device through the SATA packet interface, converts the data into data which is compatible through the PATA packet interface, and transmits the data to the ATA adjuster 130. The transmitted data is temporarily stored in the first buffer 137.

The first ATA part 133 transmits the write command received from the first host device 110 to the second ATA part 135, and transmits a GPIO busy signal ‘busy1_GPIO’ to the first host device 110 at operation S320.

The first ATA part 133 stores the data stored in the first buffer 137 to the SRAM 131 and then transmits to the second ATA part 135 a storage completion signal indicating that the data has been stored in the SRAM 131. Then, the second ATA part 135 temporarily stores the data stored in the SRAM 131 to the second buffer 139, and transmits a GPIO write command ‘write1_GPIO’ to the second host device 150 at operation S330.

On the receipt of the GPIO write command ‘write1_GPIO’, the second host device 150 reads out the data stored in the second buffer 139 at operation S340 and writes the data to the second storage part 140 at operation S350. When the data stored in the second buffer 139 is completely transmitted to the second host device 150, the first ATA part 133 clears the GPIO busy signal ‘busy1_GPIO’.

Through the above-described process, the first and the second host devices 110, 150 perform mutual data communications, and in the same method as the above-described method, the second host device 150 reads out data from the first storage part 100 or writes data to the first storage part 100.

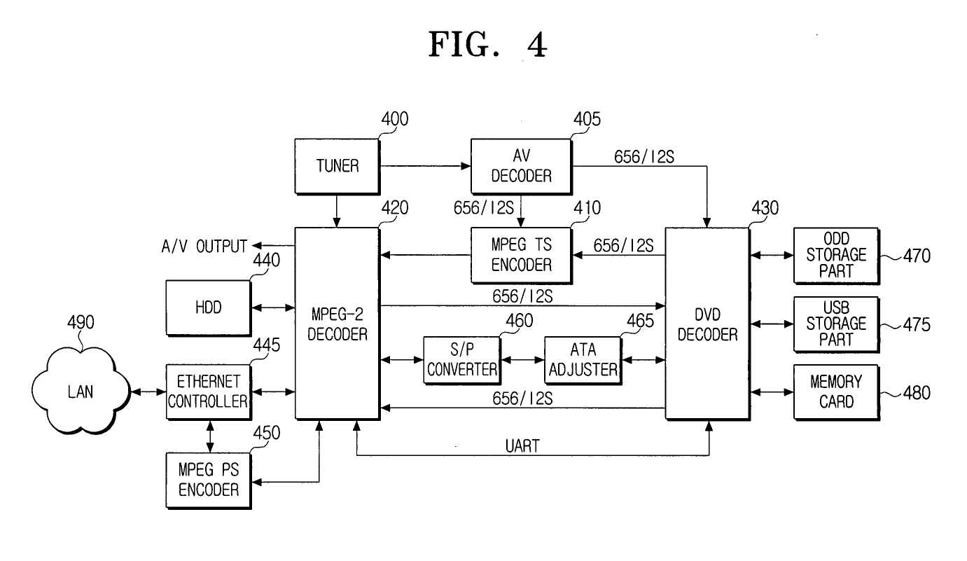

FIG. 4 is a block diagram illustrating a set-top box having a DVD function, which is one example of the combination apparatus according to an exemplary embodiment of the present invention.

Referring to FIG. 4, the set-top box having a DVD function, comprises a tuner 400, an AV decoder 405, an MPEG TS encoder 410, an MPEG-2decoder 420, a DVD decoder 430, a HDD 440, an Ethernet controller 445, an MPEG PS encoder 450, an S/P converter 460, an ATA adjuster 465, an ODD storage part 470, a USB storage part 475, and a memory card 480.

The tuner 400 comprises a first tuner (not shown) to convert a radio frequency (RF) signal received through an antenna (not shown) into a transport stream (TS) signal and a second tuner (not shown) to convert the received RF signal into a program stream (PS) signal.

The AV decoder 405 receives the PS signal output from the tuner 400, decodes a video signal included in the PS signal, and outputs an international radio consultative committee (CCIR) 656 format video signal. Also, the AV decoder 405 decodes an audio signal included in the PS signal and outputs an inter-IC sound (I2S) format audio signal.

The MPEG TS encoder 410 converts the CCIR 656 format video signal and the I2S format audio signal (these signals are referred to as 656/I2S signal hereinafter) into a TS signal, and transmits the TS signal to the MPEG-2 decoder 420.

The MPEG-2 decoder 420 processes the TS signal output from the tuner 400 and the TS signal output from the MPEG TS encoder 410 and outputs them as audio/video (A/V) or stores the A/V in the HDD 440. Also, the MPEG-2 decoder converts the TS signal into the 656/I2S signal and transmits it to the DVD decoder 430, and processes the 656/I2S signal and outputs the A/V.

The HDD 440 stores the TS signal and also JPEG and DIVX format video data and MP3 format audio data.

The DVD decoder 430 stores the 656/I2S signals received from the AV decoder 405 and the MPEG-2 decoder 420 to the ODD storage part 470, the USB storage part 475, and the memory card 480. The DVD decoder 430 converts the JPEG and DIVX format video data and the MP3 format audio data stored in the ODD storage part 470, the USB storage part 475, and the memory card 480 into the 656/I2S signal, and transmits the 656/I2S signal to the MEPG-2 decoder 420. Herein, the DVD decoder 430 and the MPEG-2 decoder 420 transmit and receive data in a universal asynchronous receiver/transmitter (UART) method.

When the MPEG-2 decoder 420, which performs a data communication through the SATA packet interface, transmits the JPEG and DIVX format video data and the MP3 format audio data stored in the HDD 440 to the S/P converter, the S/P converter 460 converts the data into data which are compatible through the PATA packet interface and transmits the converted data to the ATA adjuster 465.

Also, the S/P converter 460 converts the JPEG and DIVX format video data and the MP3 audio data, which are transmitted through the PATA packet interface, into data which are compatible through the SATA packet interface, and transmits the converted data to the MPEG-2 decoder 420.

The ATA adjuster 465 performs data communications with respect to the MPEG-2 decoder 420 and the DVD decoder 430 through the PATA packet interface. That is, the ATA adjuster 465 receives the JPEG and DIVX format video data and the MP3 audio data from the S/P converter 460 and transmits the received data to the DVD decoder 430. In the reverse way, the ATA adjuster 465 receives the JPEG and DIVX format video data and the MP3 audio data from the DVD decoder 430 and transmits the received data to the S/P converter 460.

The Ethernet controller 445 controls the TS signal output from the MPEG-2 decoder 420 to be transmitted to a personal computer (PC) through a local area network (LAN) 490. Also, the Ethernet controller 445 controls the PS signal output from the MPEG PS encoder 450 to be transmitted to the PC through the LAN 490.

The MPEG PS encoder 450 converts the TS signal output from the MPEG-2 decoder 420 into a PS signal and transmits the converted signal to the Ethernet controller 445.

The structure of the set-top box having a DVD function was described in the above. Hereinbelow, operations of the set-top box, such as live broadcasting, broadcast signal recording, playback of recorded content, time-shift, recording and reproducing, dubbing and recording, dubbing and reproducing, network integration broadcast signal reproducing, and network integration content reproducing, will now be described in detail.

Referring to FIG. 4, an exemplary broadcast signal reproducing operation of the set-top box having a DVD function will now be described.

If a broadcast signal is a high definition (HD) broadcast signal, the tuner 400 converts a RF signal received through an antenna into a TS signal and transmits the TS signal to the MPEG-2 decoder 420. The MPEG-2 decoder 420 processes the TS signal and outputs it as an A/V.

If a broadcast signal is a standard definition broadcast signal, the tuner 400 converts an RF signal received through an antenna into a PS signal and transmits the PS signal to the AV decoder 405. The AV decoder 405 converts the PS signal into a 656/I2S signal and outputs the 656/I2S signal. The 656/I2S signal is converted into a TS signal by the MPEG TS encoder 410 and transmitted to the MPEG-2 decoder 420. The MPEG-2 decoder 420 processes the TS signal and outputs it as an A/V.

Referring to FIG. 4, an exemplary broadcast signal recording operation of the set-top box having a DVD function will now be described.

The MPEG-2 decoder 420 stores a TS signal received from the tuner 400 to the HDD 440 to store an HD broadcast signal or stores a TS signal received from the MPEG-TS encoder 410 to the HDD 440 to store an SD broadcast signal.

Also, when the MPEG-2 decoder 420 converts the TS signal into a 656/I2S signal and transmits the 656/I2S signal to the DVD decoder 430, the DVD decoder 430 receives the 656/I2S signal and stores the HD broadcast signal or the SD broadcast signal to the ODD storage part 470, the USB storage part 475 and/or the memory card 480.

Referring to FIG. 4, an exemplary recorded content reproducing operation of the set-top box having a DVD function will now be described.

A TS signal stored in the HDD 440 is processed at the MPEG-2 decoder 420 and is output as an A/V.

Next, an exemplary operation of reproducing the JPEG and DIVX format video data and the MP3 format audio data stored in the HDD 440 will now be described.

The MPEG-2 decoder 420 reads out data from the HDD 440 and transmits the data to the S/P converter 460 through the SATA packet interface. The S/P converter 460 converts the SATA packet interface into the PATA packet interface and transmits the data to the ATA adjuster 130. The ATA adjuster 130 transmits the data to the DVD decoder 430.

The DVD decoder 430 converts the JPEG and DIVX format video data and the MP3 format audio data into 656/I2S signals and transmits the 656/I2S signals to the MPEG-2 decoder 420. The MPEG-2 decoder 420 processes the 656/I2S signals and outputs them as A/V.

If the JPEG and DIVX format video data and the MP3 format audio data are stored in the ODD storage part 470, the USB storage part 475, and/or the memory card 480, the DVD decoder 430 converts the data into the 656/I2S signals and transmits the 656/I2S signals to the MPEG-2 decoder 420. The transmitted 656/I2S signals are processed in the MPEG-2 decoder 420 and output as A/V.

Referring to FIG. 4, an exemplary time-shift operation of the set-top box having a DVD function will now be described.

If an HD broadcast signal is received, the MPEG-2 decoder 420 processes a TS signal stored in the HDD 440 and outputs it as an A/V, and simultaneously, stores a TS signal received from the tuner 400 to the HDD 440.

If an SD broadcast signal is received, the MPEG-2 decoder 420 processes a TS signal stored in the HDD 440 and outputs it as an A/V. Meanwhile, when the AV decoder 405 decodes a PS signal output from the tuner 400 and the MPEG TS encoder 410 outputs a TS signal, the MPEG-2 decoder 420 receives the TS signal from the MPEG TS encoder 410 and stores the TS signal to the HDD 440.

Referring to FIG. 4, an exemplary recording and reproducing operation of the set-top box having a DVD function will now be described.

If an HD broadcast signal is to be recorded and reproduced, the MPEG-2 decoder 420 stores a TS signal received through the tuner 400 to the HDD 440, and simultaneously, processes another TS signal stored in the HDD 440 and outputs it as an A/V.

If an SD broadcast signal is to be recorded and reproduced, the MPEG-2 decoder 420 reads out a TS signal from the HDD 440, process the TS signal and outputs it as an A/V. When an RF signal received through the tuner 400 is converted into a PS signal and input into the AV decoder 405, the AV decoder 405 converts the PS signal into a 656/I2S signal and outputs the 656/I2S signal. Then, the DVD decoder 430 stores the 656/I2S signal output from the AV decoder 405 to the ODD storage part 470, the USB storage part 475, and/or the memory card 480.

Referring to FIG. 4, an exemplary dubbing and recording operation of the set-top box having a DVD function will now be described.

If a broadcast signal is to be recorded to the HDD 440, the MPEG-2 decoder 420 converts a TS signal stored in the HDD 440 into a 656 signal and transmits the 656 signal to the DVD decoder 430. The DVD decoder 430 receives the 656 signal and stores it to the ODD storage part 470, the USB storage part 475, and/or the memory card 480. Meanwhile, the MPEG-2 decoder 420 records the TS signal received from the tuner 400 to the HDD 440.

In order to store a broadcast signal to the ODD storage part 470, the USB storage part 475, and/or the memory card 480, the MPEG-2 decoder 420 converts a TS signal stored in the HDD 440 into a 656 signal and transmits the 656 signal to the DVD decoder 430. The DVD decoder 430 receives the 656 signal and stores it to the ODD storage part 470, the USB storage part 475, and/or the memory card 480. Meanwhile, the MPEG-2 decoder 420 records the TS signal received from the MPEG TS encoder 410 to the HDD 440.

Referring to FIG. 4, an exemplary dubbing and reproducing operation of the set-top box having a DVD function will now be described.

The MEPG-2 decoder 420 converts a TS signal stored in the HDD 440 into a 656 signal and transmits the 656 signal to the DVD decoder 430. The DVD decoder 430 records the 656 signal to the ODD storage part 470, the USB storage part 475, and/or the memory card 480. Meanwhile, the MPEG-2 decoder 420 processes the TS signal stored in the HDD 440 and outputs it as an A/V.

Referring to FIG. 4, an exemplary network integration broadcast signal reproducing operation of the set-top box having a DVD function will now be described.

If a target signal is an HD broadcast signal, the MPEG-2 decoder 420 transmits a TS signal to the Ethernet controller 445 and the Ethernet controller 445 transmits the TS signal to the PC through the LAN 490.

If a target signal is an SD signal, the MPEG-2 decoder 420 transmits a TS signal received from the MPEG TS encoder 410 to the MPEG PS encoder 450. The MPEG PS encoder 450 converts the TS signal into a PS signal and transmits the PS signal to the Ethernet controller 445. The Ethernet controller 445 transmits the PS signal to the PC through the LAN 490.

Referring to FIG. 4, a network integration content reproducing operation of the set-top box having a DVD function will now be described.

If a content is stored in the HDD 440, the MPEG-2 decoder 420 transmits a TS signal stored in the HDD 440 to the Ethernet controller 445. The Ethernet controller 445 transmits the TS signal to the PC through the LAN 490. Alternatively, when the MPEG-2 decoder 420 transmits the TS signal stored in the HDD 440 to the MPEG PS encoder 450, the MPEG PS encoder 450 converts the TS signal into a PS signal and transmits the PS signal to the Ethernet controller 445. The Ethernet controller 445 transmits the PS signal to the PC through the LAN 490.

If a content is stored in the ODD storage part 470, the USB storage part 475 and/or the memory card 480, the DVD decoder 430 converts JPEG and DIVX format video data and MP3 format audio data stored in the ODD storage part 470, the USB storage part 475, and/or the memory card 480 into 656/I2S signals and transmits the 656/I2S signals to the MPEG-2 decoder 420. The MPEG-2 decoder 420 transmits the 656/I2S signals to the Ethernet controller 445 and the Ethernet controller 445 transmits the 656/I2S signals to the PC through the LAN 490.

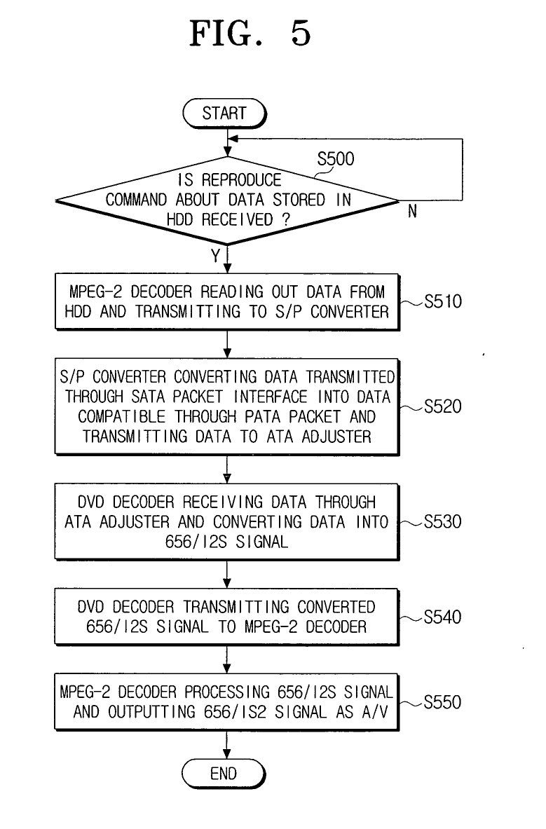

FIG. 5 is a flowchart illustrating a reproducing operation of the set-top box having a DVD function according to an exemplary embodiment of the present invention.

Referring to FIG. 5, when a reproduce command about the data stored in the HDD 440 is received at operation S500, the MPEG-2 decoder 420 reads out the data from the HDD 440 and transmits the data to the S/P converter 460 at operation S510. The data maybe JPEG and DIVX format video data and MP3 format audio data stored in the HDD 440 and are transmitted without changing their own formats.

The S/P converter 460 converts the data, which are transmitted through the SATA packet interface, into data that are compatible through the PATA packet interface, and transmits the converted data to the ATA adjuster 465 at operation S520.

The DVD decoder 430 receives the data through the ATA adjuster 130 and converts the data into 656/I2S signals at operation S530.

When the DVD decoder 430 transmits the 656/I2S signals to the MPEG-2 decoder 420 at operation S540, the MPEG-2 decoder 420 processes the 656/I2S signals and outputs them as A/V at operation S550.

Through the above-described process, the JPEG and DIVX format video data and the MP3 format audio data are transmitted and received between the MPEG-2 decoder 420 and the DVD decoder 430 and are reproduced without changing their own formats.

According to exemplary embodiments of the present invention as described above, since the data communication is performed through the ATA packet interface without changing the formats of data, a third host device is not required. Therefore, a more effective system can be established and power consumption and a cost of the product can be reduced.

While the invention has been shown and described with reference to certain exemplary embodiments thereof, it will be understood by those skilled in the art that various changes in the form and details may be made therein without departing from the spirit and scope of the invention as defined by the appended claims and the full scope of equivalents thereof.

What is claimed is:

1. A combination apparatus comprising:
a first host device that controls a first function block to perform a first function;
a second host device that controls a second function block to perform a second function; and
a host device interface adjuster that performs a data communication between the first host device and the second host device.

2. The combination apparatus as claimed in claim 1, wherein the host device interface adjuster comprises:
a first host device interface part that receives at least one of a read command and a write command from the first host device;
a second host device interface part that receives the at least one command from the first host device interface part and transmits the at least one received command to the second host device;
a first buffer that temporarily stores data transmitted from at least one of the first host device and the first host device interface part according to the at least one command;
a second buffer that temporarily stores data transmitted from at least one of the second host device and the second host device interface part according to the at least one command; and
a memory device that stores data transmitted from at least one of the first host device interface part and the second host device interface part.

3. The combination apparatus as claimed in claim 2, wherein the first host device interface part stores the data temporarily stored in the first buffer to the memory device and then transmits to the second host device interface a storage completion signal indicating that the data has been stored to the memory device, and
wherein the second host device interface part transmits the data stored in the memory device to the second buffer when receiving the storage completion signal.

4. The combination apparatus as claimed in claim 3, wherein, when the first host device transmits data to the second host device, the first host device temporarily stores the data in the first buffer and the second host device reads out the data temporarily stored in the second buffer.

5. The combination apparatus as claimed in claim 1, wherein the host device interface adjuster transmits and receives the data through a parallel data interface.

6. The combination apparatus as claimed in claim 5, further comprising a converter that, if the first host device performs a data communication through a serial data interface, converts the serial data interface performed between the first host device and the host device interface adjuster into a parallel data interface and converts a parallel data interface into a serial data interface.

7. A data communication method of a combination apparatus which performs a data communication between a first host device and a second host device through a parallel data interface, the method comprising:
receiving at least one of a read command and a write command from the first host device;
transmitting a busy signal to the first host device when receiving the read command;
transmitting the read command to the second host device; and
receiving data corresponding to the read command from the second host device and transmitting the data to the first host device through a parallel data interface.

8. The method as claimed in claim 7, wherein, if the first host device uses a serial data interface, the operation of transmitting the data to the first host device through the parallel data interface comprises converting the parallel data interface into the serial data interface and then transmitting the data.

9. The method as claimed in claim 7, further comprising:
if the write command is received, receiving data corresponding to the write command from the first host device;
transmitting a busy signal to the first host device;
transmitting the write command to the second host device; and
transmitting the data to the second host device through a parallel data interface.

10. The method as claimed in claim 9, wherein, if the first host device uses a serial data interface, the operation of transmitting the data to the second host device through the parallel data interface further comprises converting the serial data interface into the parallel data interface.

11. A set-top box having a multi-media function, comprising:
a memory that stores at least one of video data and audio data;
a first decoder that reads out at least one data of the video data and the audio data from the memory;
a converter that converts the data read by the first decoder through a serial data interface into data that is compatible through a parallel data interface;
a host device interface adjuster that performs a data communication with respect to the data through the parallel data interface; and
a second decoder that receives the data through the host device interface adjuster.

12. The set-top box as claimed in claim 11, wherein the second decoder converts the data into formatted video data and formatted audio data, and transmits the converted data to the first decoder.

13. The set-top box as claimed in claim 12, wherein the first decoder receives the formatted video data and the formatted audio data and outputs the data as a video and an audio.

14. A content reproducing method comprising:
reading out at least one of compressed digital video data and compressed digital audio data;
performing a data communication with respect to the compressed data through a parallel data interface;
converting the data into formatted video data and formatted audio data; and
outputting the formatted video data and the formatted audio data as a video and an audio.

15. The method as claimed in claim 14, further comprising converting the data read through a serial data interface into data that is compatible through the parallel data interface.

16. The combination apparatus as claimed in claim 1, wherein the host device interface adjuster comprises an advanced technology attachment (ATA) adjuster that performs the data communication through an ATA packet interface.

17. The combination apparatus as claimed in claim 2, wherein the first host device interface part comprises a first ATA part, the second host device interface part comprises a second ATA part and the memory device is an SRAM.

18. The combination apparatus as claimed in claim 5, wherein the parallel data interface comprises a parallel ATA (PATA) packet interface.

19. The combination apparatus as claimed in claim 6, wherein the converter comprises a serial/parallel converter and the serial data interface comprises a serial ATA (SATA) packet interface.

20. The data communication method of claim 7, wherein the parallel data interface comprises a parallel ATA (PATA) packet interface.

21. The data communication method of claim 8, wherein the serial data interface comprises a serial ATA (SATA) packet interface.

22. The set-top box as claimed in claim 11, wherein the multi-media function comprises a DVD function, the first decoder comprises a compressed data decoder, the video data comprises compressed digital video data, the audio data comprises compressed digital audio data, the converter comprises a data format converter, and the second decoder comprises a multi-media decoder.

23. The set-top box as claimed in claim 22, wherein the memory device comprises an HDD, the compressed data decoder comprises an MPEG-2 decoder, the compressed digital video data comprises at least one of JPEG and DIVX format video data, the compressed digital audio data comprises MP3 format audio data, the data format converter comprises a serial-to-parallel (S/P) converter, the host device interface adjuster comprises an advanced technology attachment (ATA) adjuster and the multi-media decoder comprises a DVD decoder.

24. The set-top box as claimed in claim 12, wherein the formatted video data comprises international radio consultative committee (CCIR) 656 format video data and the formatted audio data comprises inter-IC sound (I2S) format audio data.

25. The content reproducing method of claim 14, wherein the compressed digital video data comprises at least one of JPEG and DIVX format video data, the compressed digital audio data comprises MP3 format audio data, the parallel data interface comprises a parallel advanced technology attachment (PATA) interface, the formatted video data comprises international radio consultative committee (CCIR) 656 format video data and the formatted audio data comprises inter-IC sound (I2S) format audio data.

26. The content reproducing method of claim 15 wherein the serial data interface comprises a serial ATA (SATA) packet interface.
